(19) United States
(12) Patent Application Publication
(10) Pub. No.: US 2013/0243064 A1
(43) Pub. Date: Sep. 19, 2013

(54) EXPERT ANTENNA CONTROL SYSTEM

(71) Applicants: John WONG, San Jose, CA (US); Thomas E. PARE, JR., Mountain View, CA (US); Gary A. ANWYL, Palo Alto, CA (US); Kiran ULN, Pleasanton, CA (US); Chih-Liang CHANG, Yung Kang City (TW)

(72) Inventors: John WONG, San Jose, CA (US); Thomas E. PARE, JR., Mountain View, CA (US); Gary A. ANWYL, Palo Alto, CA (US); Kiran ULN, Pleasanton, CA (US); Chih-Liang CHANG, Yung Kang City (TW)

(73) Assignee: MEDIATEK SINGAPORE PTE. LTD., Singapore (SG)

(21) Appl. No.: 13/424,244

(22) Filed: Mar. 19, 2012

(51) Int. Cl. H04B 17/00; H04B 7/02

(52) U.S. Cl. 375/227; 375/224

(57) ABSTRACT

A method and system for actively selecting antenna sets for a client are disclosed. In a first aspect, the method comprises sending a first channel packet from a transmitter to a receiver and sending a second channel packet corresponding to the received first channel packet from the receiver to the transmitter. The method includes collecting statistics of an antenna set related to the sending of the first and the second channel packets. The method includes comparing the collected statistics to previously collected statistics of another antenna set to select one of the antenna set and the another antenna set. In a second aspect, the system comprises a processor and a memory device coupled to the processor, wherein the memory device stores an application which, when executed by the processor, causes the processor to carry out the steps of the method.

### FIELD OF THE INVENTION

The present invention relates to a wireless communications, and more particularly, to an expert antenna control system.

### BACKGROUND

Wireless communication systems communicate between a variety of antenna systems that vary in performance and reception quality. Selecting an appropriate antenna system enhances the transmission and reception of data information that is wirelessly communicated between devices. Some conventional systems choose the most optimal antenna system for all clients but this often favors a select few clients and negatively affects the other clients.

Additionally, some other conventional systems build custom wireless network systems to choose the best antenna system for each client and allocate the air time among multiple clients. However, building custom wireless network systems is costly and time consuming and requires special protocols and buffers to be in place.

These issues limit the performance of the wireless throughput of wireless communication devices. Therefore, there is a strong need for a cost-effective solution that overcomes the above issues and creates an antenna selection system that supports per-packet antenna selection by evaluating the performance of the channel and uses the best antenna set associated with each client to increase the performance of the wireless throughput. The present invention addresses such a need.

### SUMMARY OF THE INVENTION

A method and system for actively selecting antenna sets for a client are disclosed. In a first aspect, the method comprises sending a first channel packet from a transmitter to a receiver and sending a second channel packet corresponding to the received first channel packet from the receiver to the transmitter. The method includes collecting statistics of an antenna set related to the sending of the first and the second channel packets. The method also includes comparing the collected statistics to previously collected statistics of another antenna set to select one of the antenna set and the another antenna set.

In a second aspect, the system comprises a processor and a memory device coupled to the processor, wherein the memory device stores an application which, when executed by the processor, causes the processor to carry out the steps of the method.

### BRIEF DESCRIPTION OF THE DRAWINGS

The accompanying drawings illustrate several embodiments of the invention and, together with the description, serve to explain the principles of the invention. One of ordinary skill in the art will recognize that the particular embodiments illustrated in the drawings are merely exemplary, and are not intended to limit the scope of the present invention.

FIG. 1 illustrates an expert antenna control system in accordance with an embodiment.

FIG. 2 illustrates an active antenna probe in accordance with an embodiment.

FIG. 3 illustrates a method for actively selecting antenna sets for a client in accordance with an embodiment.

### DETAILED DESCRIPTION OF PREFERRED EMBODIMENTS

The present invention relates to a wireless communications, and more particularly, to an expert antenna control system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

A method and system for actively selecting antenna sets for a client are disclosed. The method comprises periodically scanning for a better antenna set for a particular client to adapt to a changing environment. The method includes actively injecting a channel check packet (CCP) and receiving a channel response packet (CRP) for the current antenna set and possible next antenna sets. In response to the injecting and receiving, the method includes collecting and comparing statistics to predict the quality of a channel to select one of the antenna sets and allow for per-packet control.

To describe the features of the present invention in more detail, refer now to the following description in conjunction with the accompanying Figures.

Expert Antenna Control System:

The expert antenna control system can work with any antenna arrays and involves both software as well as multiple hardware functional blocks working closely together to probe and evaluate the best antenna set and direct the transmit and receive antennas to maximize the data transfer rate.

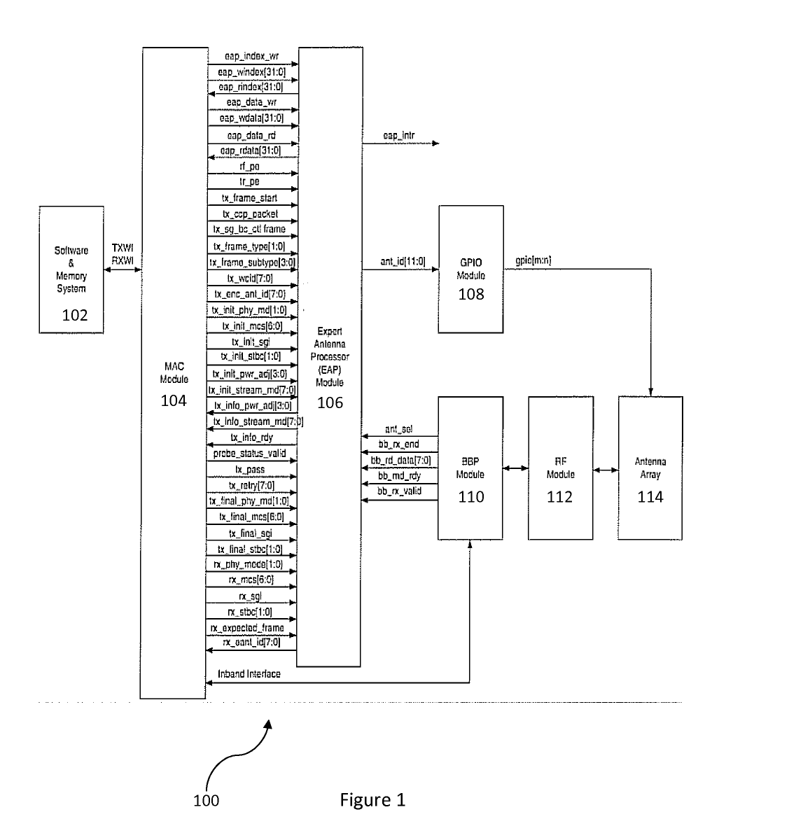

FIG. 1 illustrates an expert antenna control system 100 in accordance with an embodiment. The expert antenna control system 100 includes a software and memory system 102, a media access control (MAC) module 104 coupled to the software and memory system 102, an expert antenna processor (EAP) module 106 coupled to the MAC module 104, and a general purpose input/output (GPIO) module 108 coupled to the EAP module 106. The expert antenna control system 100 further includes a baseband processor (BBP) module 110 coupled to the MAC module 104, a radio frequency (RF) module 112 coupled to the BBP module 110, and an antenna array 114 coupled to the RF module 112 and to the GPIO module 108.

In the expert antenna control system 100, software works in conjunction with hardware to perform antenna selection through a transmit wireless interface (TXWI) and a receive wireless interface (RXWI) in the software and memory system 102. For each transmit (Tx) and receive (Rx) packet, the MAC module 104 sends various information to the EAP module 106 for the antenna selection. The MAC module 104 also reports the receive status to the RXWI for each packet and reports both the transmit and receive status of a channel check packet/channel response packet (CCP/CRP) exchange to the EAP module 106.

In the expert antenna control system 100, the EAP module 106 performs the transmit and receive antenna selection and an active antenna probe first in/first out (FIFO). The GPIO module 108 sends antenna selection control signals to the general purpose inputs and outputs (I/Os). The antenna array 114 selects the antenna set for the transceivers based on the antenna selection control signals through the general purpose I/Os. The RF module 112 performs up/down conversions between the selected antennas and the BBP module 110. The BBP module 110 performs automatic gain control (AGC) antenna diversity in the process of receiving a packet.

An antenna selection ID is used in the expert antenna control system 100 to configure the antenna array 114. The antenna selection ID selects one antenna set out of all possible antenna sets. In one embodiment, the antenna selection ID is 12 bits to support up to four-transceiver systems. One of ordinary skill in the art readily recognizes that the antenna selection ID can be represented by various bits and that would be within the spirit and scope of the present invention. In one embodiment, as shown in Diagram 1, each of the bits in the antenna selection ID are used to select one out of two antennas in a three-transceiver system. Thus, in Diagram 1, three antenna selection ID bits are used to select three out of six antennas.

Software/Hardware Interface:

Additional fields of TXWI and RXWI allow the expert antenna control system 100 to perform the antenna selection with per-packet control and a status report. The TXWI additional field (Diagram 2) supports per-packet transmit antenna selection, transmit power adjustment, stream mode control, and channel check packet (CCP). The RXWI additional field (Diagram 3) reports per-packet antenna selection, per-space-time-stream (per-STS) signal to noise ratio (SNR), and per-receiver received signal strength indication (RSSI).

The TXWI signals are described in Table 1 and the RXWI signals are described in Table 2. The C/S column indicates whether the signal is for control or for status report. All newly added TXWI fields are for control only and all newly added RXWI fields are for status report only.

TABLE 1
TXWI Signal Description

| Signal Name | C/S | Description |
|---|---|---|
| CCP | C | Channel Check Packet. |
| | | This bit indicates to the MAC to |
| | | report that the current packet is |
| | | a CCP packet. All frame |
| | | formats are supported, but |
| | | NULL DATA FRAME is |
| | | recommended. |
| Encoded_ant_id[7:0] | C | Transmit Encoded Antenna ID. |
| Tx_stream_mode[7:0] | C | Transmit Stream Mode |
| | | Control. |
| Tx_pwr_adj[3:0] | C | Transmit Power Adjustment. |
| | | It can make a transmit power |
| | | adjustment of −16 dB to +7 dB. |
| | | When negative, each unit |
| | | represents 2 dB; when positive, |
| | | each unit represents 1 dB. |

TABLE 2
RXWI Signal Description

| Signal Name | C/S | Description |
|---|---|---|
| encoded_ant_id[7:0] | S | Receive Encoded Antenna ID. |
| Sts0_snr[7:0] | S | STS0 SNR. |
| Sts1_snr[7:0] | S | STS1 SNR. |
| Rx0_rssi[7:0] | S | Rx0 RSSI. |
| Rx1_rssi[7:0] | S | Rx1 RSSI. |

Active Antenna Probe:

The active antenna probe scans for a better antenna selection for a particular client periodically over a predetermined time period to adapt to a changing environment. One of ordinary skill in the art readily recognizes that the predetermined time period can be represented by a variety of time periods including but not limited to 500 millisecond (ms) intervals and that would be within the spirit and scope of the present invention.

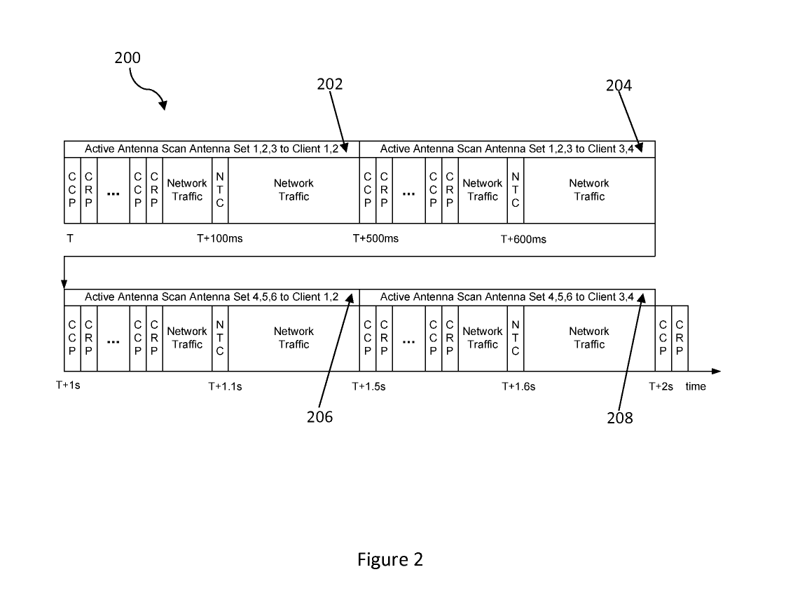

FIG. 2 illustrates an active antenna probe 200 in accordance with an embodiment. The active antenna probe 200 performs a partial or full active antenna scan to a number of clients in round-robin fashion to minimize system performance degradation and maximize the antenna set adaptation capability for each client. In the active antenna probe 200, antenna sets 1, 2, 3 to client 1, 2 are scanned via step 202, antenna sets 1, 2, 3 to client 3, 4 are scanned via step 204, antenna sets 4, 5, 6 to client 1, 2 are scanned via step 206 and antenna sets 4, 5, 6 to client 3, 4 are scanned via step 208.

In one embodiment, in a two transceiver and two receiver system (2T2R), a full antenna probe for the four most important clients specified by the system administrator or for the four fastest changing clients and a partial antenna probe for the rest of the clients can be applied in round-robin fashion.

The active antenna probe 200 actively injects a channel check packet (CCP) and receives a channel response packet (CRP) for the current antenna set and the possible next antenna sets. A channel checker sends the CCP to a channel checkee, and the channel checkee sends back a corresponding channel response packet (CRP) to the channel checker. The channel checker uses the same antenna selection ID for both the CCP and the CRP to focus the testing on a particular antenna set. During this CCP/CRP exchange (Diagram 3), the channel checker must use the same antenna set to transmit the CCP packet and receive the CRP packet.

Any packet can be composed by software and used for the CCP by setting the CCP bit in the TXWI as shown by Diagram 2. The transmission of the CCP may not be successful using a particular antenna set; therefore, NULL DATA FRAME of any packet length is recommended for the CCP transmission to avoid the higher/upper network layer having to resend the packet which helps minimize the networking impact of testing bad antenna sets and unsuccessful transmit attempts. Thus, network traffic DATA FRAME for the CCP transmission should be avoided. One of ordinary skill in the art readily recognizes that the CCP transmission can be represented by a variety of transmission types including but not limited to a request to send (RTS) frame, a unicast control frame and a unicast management frame and that would be within the spirit and scope of the present invention.

The active antenna probe 200 may use any existing MAC layer frame by tagging the CCP in the TXWI of the frame to be interoperable to the IEEE 802.11a/b/g/n standard for wireless communications. In one embodiment, high-priority transmit queues, located within the MAC module 104, enhance the performance of the CCP transmission. All packets go through the high-priority transmit queues resulting in a shortened transmit latency from the software having the packet ready in the software and memory system 102 to the packet actually being sent. As a result, when a higher quality of service is used, the latency from the CCP transmission to a status report of the CCP/CRP exchange is shortened and optimized.

In the CCP/CRP exchange, four types of status information are generated from the CCP transmission and the CRP reception to predict the quality of the channel at both the channel checker and the channel checkee as shown in Table 3. In the IEEE 802.11 standard for wireless communications, status information is not visible from both sides of the channel checker and the channel checkee. As a result, only status information pertaining to the channel checker is available and collected in the expert antenna control system 100.

One of ordinary skill in the art readily recognizes that when the design of the expert antenna control system 100 is not under the IEEE 802.11 standard, the status information can be included in the payload of the channel response packet (CRP) and transmitted back to the channel checker and that would be within the spirit and scope of the present invention. In this embodiment, all of the status information pertaining to both the channel checker and the channel checkee are available and can be collected in the expert antenna control system 100.

TABLE 3
CCP/CRP Exchange Status Information

| Packet | Channel Checker Status | Channel Checkee Status |
|---|---|---|
| CCP | Transmit (Tx) Pass/Fail, Tx | MCS, RSSI, Per-STS SNR, |
| | Retry Number, Initial | Per-receiver SNR (Not |
| | Modulation and Coding | available) |
| | Scheme (MCS), Final MCS | |
| CRP | MCS, RSSI, Per-STS SNR, | Tx Pass/Fail, Retry Number, |
| | Per-receiver SNR | Initial MCS, Final MCS (Not |
| | | available) |

The CCP/CRP exchange status information is saved in the probe FIFO which stores up to thirty-two entries. One of ordinary skill in the art readily recognizes that the probe FIFO can store up to different numbers of entries and that would be within the spirit and scope of the present invention. The probe FIFO is accessible to the software through a register interface within the EAP module 106. The probe FIFO has interrupt threshold support to trigger a probe interrupt and also has semaphore support to take care of a reading out of the CCP/CRP exchange status information and the arrival of a new CCP/CRP exchange status information each occurring at the same time. The probe FIFO stores additional information in addition to the CCP/CRP exchange status information for identification purposes including but not limited to the information as shown in Table 4.

TABLE 4
Probe FIFO Information

| Packet | Probe FIFO Status |
|---|---|
| CCP | Destination WCID - 8 bits |
| CCP | Transmit Encoded Antenna |
| | Selection - 8 bits |
| CCP | Pass/Fail - 1 bit |
| CCP | Retry Number - 8 bits |
| CCP | Initial MCS Rate (PHY_MD, |
| | MCS, SGI, STBC) - 12 bits |
| CCP | Final MCS Rate (PHY_MD, |
| | MCS, SGI, STBC) - 12 bits |
| CRP | MCS Rate (PHY_MD, MCS, |
| | SGI, STBC) - 12 bits |
| CRP | Receive Encoded Antenna |
| | Selection - 8 bits |
| CRP | Per-receiver RSSI × 2 - 16 bits |
| CRP | Per-STS SNR × 2 - 16 bits |
| CRP | Per-receive SNR × 2 - 16 bits |

After the CCP/CRP exchange status information and statistics of a certain antenna set for a particular client are generated, collected and saved in the Probe FIFO, the software analyzes and compares the status information and statistics and updates the antenna set for the particular client with a predictably-better antenna set. In the active antenna probe 200, if the original antenna set for a particular client is switched to the predictably-better antenna set, the software performs a network traffic check (NTC) after a predetermined time period, including but not limited to 100 ms, to confirm the predictably-better antenna set. If transmit packet error rates are high, the active antenna probe 200 reverts back to the original antenna set for the particular client.

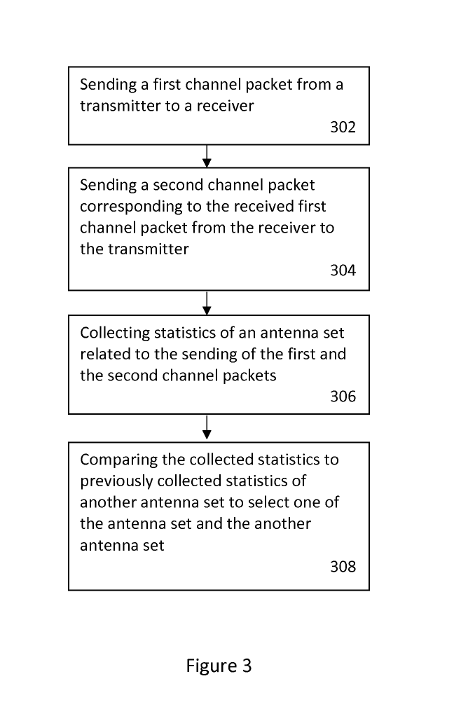

FIG. 3 illustrates a method 300 for actively selecting antenna sets for a client in accordance with an embodiment. The method 300 includes sending a first channel packet from a transmitter to a receiver, via step 302 and sending a second channel packet corresponding to the received first channel packet from the receiver to the transmitter, via step 304. In one embodiment, both the first channel packet and the second channel packet include an antenna selection ID. The method 300 further includes collecting statistics of an antenna set related to the sending of the first and the second channel packets, via step 306 and comparing the collected statistics to previously collected statistics of another antenna set to select one of the antenna set and the another antenna set, via step 308.

In one embodiment, the method 300 includes performing a NTC after a predetermined time period in response to selecting the antenna set to confirm the selection of the antenna set or reverting back to the another antenna set in response to detecting high transmit packet error rates. In another embodiment, the method 300 includes performing a partial antenna probe or a full antenna probe to a plurality of clients in round-robin fashion to minimize system performance degradation and maximize the antenna set adaptation capability for each client.

Multiple-User Focused Antenna Selection:

In the active antenna probe 200, a predictably-better antenna set is found for each particular client. During the transmit process, the predictably-better antenna set as well as other transmit tuning parameters, including but not limited to per-packet transmit antenna selection, per-packet transmit power adjustment and per-packet transmit stream mode control, can be used through the TXWI interface.

The per-packet transmit power adjustment to a client uses the result of RSSI from a received packet of a particular client or the CRP RSSI. If the RSSI from the particular client is too high, the client is too close in proximity and so the transmit power may be lowered to enhance transmission to the client. One of ordinary skill in the art readily recognizes that when both an access point (AP) and the client use per-packet transmit power adjustment, proximity information may be inaccurate and may introduce unstable feedback loop and that would be within the spirit and scope of the present invention.

In another embodiment, the access point (AP) applies the per-packet transmit power adjustment for transmitting the CCP to a certain client. From the CCP/CRP exchange status information, the AP determines an optimal per-packet power adjustment for transmitting a regular packet (non-CCP). In one embodiment, the AP transmits both a low-power and a high-power CCP to a client and then collects both the low-power and high-power CCP status information to determine whether low-power or high-power is more optimal to transmit the regular packet. In this embodiment, the per-packet transmit power adjustment is operative on both the access point (AP) and the client at the same time.

The per-packet transmit stream mode control includes the cyclic shift delay (CSD) adjustment and the stream mode type in the TXWI interface.

The best antenna set is used to receive from a certain associated client. In one embodiment, in the 802.11 protocol, after a certain transmission to a client of a packet including but not limited to DATA FRAME, RTS FRAME, CTS FRAME, and PS-POLUCF-POLL FRAME, the system respectively receives ACK FRAME, CTS FRAME, DATA FRAME, and ACK/DATA FRAME back from the same client. Since transmitting and receiving to/from is on the same client, the best antenna set is used for both the transmit/receive packets.

One of ordinary skill in the art readily recognizes that there can be a multiple of DATA FRAMES expecting to receive in several fragments and that would be within the spirit and scope of the present invention. If these fragments are transmitted within the short interframe space (SIFS) time, the expert antenna control system 100 will still be able to receive the fragments with the best antenna set.

For asymmetrical link clients, multiple-user focused transmit/receive may be disabled. Such clients may use one antenna for transmission and another antenna for reception. As a result, one of ordinary skill in the art readily recognizes that for asymmetrical link clients, the best antenna set based on the CCP/CRP exchange status information may be inaccurate.

Additional Features:

In one embodiment, the expert antenna control system 100 includes an all-directional antenna set. The all-directional antenna set guarantees connection for associated as well as unassociated clients in all directions thus covering a geological area around the expert antenna control system 100. The all-directional antenna set is based on the topology of an antenna array of the expert antenna control system 100 and can be derived from the characteristics of the antenna array. One of ordinary skill in the art readily recognizes that the all-directional antenna set can be a variety of devices including but not limited to an antenna set which includes omni-directional antennas and that would be within the spirit and scope of the present invention.

In one embodiment, the expert antenna control system 100 includes an optimal antenna set. The optimal antenna set is optimal for all associated clients and maximizes the transmission/reception rate of the weakest associated clients. The optimal antenna set can be derived from parameters including but not limited to transmit and receive packet error rates (PER) and rate adaptation results such as transmit rates to all clients or a subset of clients.

In one embodiment, the expert antenna control system 100 includes a default antenna set. The optimal antenna set is time-interleaved with the all-directional antenna set to form the default antenna set. The default antenna set optimizes the performance when the transmit destination or the receive source is not known by enhancing the data transfer for the associated clients and allowing communications with the unassociated clients.

In one embodiment, each client's antenna set is a doublet including the original antenna set and a diversity antenna set to support the per-packet antenna diversity control when receiving a packet. After receiving only one packet, the AGC chooses the best antenna set out of the doublet of antenna sets. The diversity antenna set is typically the second best antenna set for the client.

In one embodiment, the expert antenna control system 100 includes packet detection that detects packets from any one receiver or multiple receivers. One of ordinary skill in the art readily recognizes that there is no omni-directional antenna requirement in the expert antenna control system 100 and so all antennas may be directional resulting in some antennas not being able to receive a signal when receiving a packet. Thus, the packet detection must detect a packet in a primary or a secondary receiver to increase signal detection.

In one embodiment, the expert antenna control system 100 includes an access point (AP) that utilizes the CCP/CRP exchange status information to determine an optimal transmission rate of sending a packet to a client. The CCP/CRP exchange status information includes a series of CCP/CRP exchanges with varying transmission rates to a particular client. The AP collects and analyzes the series of CCP/CRP exchanges to determine the optimal transmission rate for the particular client.

Software Tasks:

Each component of the expert antenna control system 100 is responsible for a variety of tasks. One of ordinary skill in the art readily recognizes that the software in the expert antenna control system 100 assists in a variety of tasks including but not limited to the operation of the active antenna probe, multiple-user focused antenna selection, and optimal antenna selection and that would be within the spirit and scope of the present invention.

For the active antenna probe, the software initiates the probe in predetermined time intervals such as 500 ms. Although any packet type can be used for the CCP by a TXWI.CCP bit to probe the condition of the channel, one of ordinary skill in the art readily recognizes that NULL Data, Control, and Management Frames are preferred because the potential loss of these packets during the active antenna probe 200 will not result in a higher required network layer for re-transmission which degrades the overall network performance and that would be within the spirit and scope of the present invention.

After the transmission of the CCP, the software analyzes the CCP/CRP exchange status information collected by the probe FIFO and determines including but not limited to the per-packet antenna selection, transmit power adjustment, and transmit stream mode control for each tested client. The software also updates the wireless client ID (WCID) to antenna selection, transmit power adjustment, and transmit stream mode control table inside the EAP module 106 for the MAC-generated control frames.

For each transmit packet, the software fills out additional information in the TXWI including but not limited to the per-packet transmit antenna ID, transmit power adjustment, and the transmit stream mode control. The software also determines the optimal antenna selection and programs it into the EAP module 106.

GPIO Module And BBP Module Tasks:

The GPIO module 108 multiplexes the antenna selection ID. One of ordinary skill in the art readily recognizes that partial antenna selection ID multiplexing depends on the number of bits needed to control the antenna array and that depending on the number of GPIO pins in the system, ant_id[11:0] can be lowered to ant_id[8:0] for two transceiver systems and that would be within the spirit and scope of the present invention. There may be an asynchronous delay from the ant_id[11:0] to gpio[n+11:n].

One of ordinary skill in the art readily recognizes that the BBP module 110 assists in a variety of tasks including but not limited to adding stream mode control and per-packet transmit power adjustment to an inband transmit info interface, providing both per-STS SNR and per-receiver SNR calculations in hardware, adding the per-STS SNR and per-receiver SNR to a receive inband status report interface, detecting AGC packets on any receive or any combination of receivers utilizing a generalized likelihood ratio test (GLRT) algorithm, adding the per-packet transmit power adjustment to a Transmitter Signal Strength Indicator (TSSI) entry, and implementing a power adjustment threshold for TSSI filtering and that would be within the spirit and scope of the present invention.

An analog to digital controller (ADC6) is configured to measure the TSSI for Tx0, Tx1, or both Tx0 and Tx1 using a temperature sensor. In the TSSI entry, packet information including but not limited to per-packet power adjustment is recorded to allow the software to determine a required Automatic Power Level Control (ALC) adjustment on the transmitters. A power adjustment threshold is utilized to filter out unwanted and inaccurate TSSI entries. One of ordinary skill in the art readily recognizes that the power adjustment threshold can be a variety of thresholds including but not limited to −16 dB to +7 dB and that would be within the spirit and scope of the present invention. In one embodiment, when the per-packet power adjustment is greater than or equal to the power adjustment threshold, TSSI is recorded.

MAC Module Tasks:

One of ordinary skill in the art readily recognizes that the MAC module 104 assists in a variety of tasks including but not limited to serving as an interface to an EAP register, determining CCP/CRP exchange status information reports and RXWI status reports, processing Tx info power adjustment and Tx info stream mode control information, routing TXWI information to the BBP module 110, and expecting to receive handling and that would be within the spirit and scope of the present invention.

The MAC module 104 utilizes two register locations on a memory map, EAP index register and EAP data register, to serve as the interface to the EAP register. For the CCP/CRP exchange, the MAC module 104 reports all status information except rx0_rssi, rx1_rssi, rx0_snr, rx1_snr, sts0_snr, and sts1_snr to the EAP as indicated in Table 4. The BBP module 110 reports rx0_rssi, rx1_rssi, rx0_snr, rx1_snr, sts0_snr, and sts1_snr directly to the EAP module 106. The MAC module also removes the CCP/CRP result for the existing Tx Status FIFO which is used for the rate adaptation algorithm.

The MAC module 104 processes and routes Tx info power adjustment and Tx info stream mode control information to the BBP module 110. In one embodiment, for all transmit frames including MAC-generated frames, the MAC module 104 first sends the TXWI or transmit information to the EAP module 106. The EAP module 106 sends back to the MAC module 104 the Tx info power adjustment and Tx info stream mode control information. The MAC module 104 also looks up the MCS power control information based on the current transmission rate and then sends the MCS power control, Tx info power adjustment, Tx info stream mode control, and transmit packet data information to the BBP module 110. The MAC module 104 reports the receive antenna selection, per-STS SNR, and per-receive SNR information from the BBP module 110 to the RXWI.

The MAC module 104 determines the receive antenna prediction utilizing the MAC layer protocol. When the MAC module 104 expects to receive a packet from a specific client, it asserts a signal including but not limited to rx_expected_frame to request the EAP module 106 for per-packet receive antenna selection support. Additionally, the MAC module 104 utilizes the antenna set of the last transmitted packet for receiving when expecting to receive from a certain client.

One of ordinary skill in the art readily recognizes that the MAC module 104 will handle extensive expecting to receive protocol handling situations including but not limited to an ACK-required DATA frame exchange, an expect to receive extension, an expect to receive inactivity early termination, an expect to receive transmit early termination, a RTS/CTS/DATA exchange, a power save poll exchange, a CF-POLL exchange in point coordination function (PCF), and a CF-POLL exchange in hybrid coordination function (HCF) and that would be within the spirit and scope of the present invention.

One of ordinary skill in the art readily recognizes that the extensive expecting to receive handling situations always occur in reduced or short interframe space (RIFS/SIFS) time and that as a result, simplification can be made to the protocol and that would be within the spirit and scope of the present invention. In one embodiment, the rx_expected_frame is deasserted during the transmit packet. After each transmit packet, the expecting to receive protocol is utilized for packets received within the RIFS/SIFS time period. Packets received after the RIFS/SIFS time period result in a stopping of the expecting to receive protocol for all following received packets.

EAP Module Tasks:

One of ordinary skill in the art readily recognizes that the EAP module 106 assists in a variety of tasks including but not limited to serving as an interface to the EAP register utilizing two register locations on the memory map in similar fashion as the MAC module 104, providing mapping tables, providing a programmable default encoded antenna ID, and providing the probe FIFO and that would be within the spirit and scope of the present invention.

The EAP module 106 provides an encoded antenna ID to antenna ID mapping table that is a 256-entry hardware lookup table within the EAP module 106. One of ordinary skill in the art readily recognizes that the lookup table can include a variety of entry numbers and that would be within the spirit and scope of the present invention.

For every WCID, there is a main encoded antenna ID, a diversity encoded antenna ID, a transmit power adjustment, and a transmit stream mode control for MAC-generated packets. In one embodiment, this information is provided for all software-generated packets. In this embodiment, the software does not specify the TXWI encoded antenna ID and instead relies on the EAP module 106 to perform an encoded antenna ID lookup utilizing a WCID to encoded antenna ID mapping table that is a 256-entry hardware lookup table within the EAP module 106.

The EAP module 106 provides a programmable default encoded antenna ID that interleaves between an optimal antenna ID and an all-directional ID. One of ordinary skill in the art readily recognizes that the options as well as the interleave periods are programmable by a variety of registers including but not limited to an all-directional encoded antenna ID register, an optimal encoded antenna ID register, an all-directional encoded antenna ID duty cycle register, and an optimal encoded antenna ID duty cycle register and that would be within the spirit and scope of the present invention.

As above described, the method and system allow for actively selecting antenna sets for a client by periodically scanning for better antenna sets in response to changing environments. By implementing the injection of a channel check packet (CCP) and the collection and comparison of network related statistics, the method and system in accordance with the present invention achieve a more robust antenna control system that works well in both static and dynamic environments because the performance does not depend heavily on network traffic patterns like traditional antenna selection systems that passively analyze the throughput of a certain antenna selection with the network traffic.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for actively selecting antenna sets for a client, the method comprising:
sending a first channel packet from a transmitter to a receiver;
sending a second channel packet corresponding to the received first channel packet from the receiver to the transmitter;
collecting statistics of an antenna set related to the sending of the first and the second channel packets; and
comparing the collected statistics to previously collected statistics of another antenna set to select one of the antenna set and the another antenna set.

2. The method of claim 1, further comprising:
in response to selecting the antenna set, performing a network traffic check (NTC) after a predetermined time period to confirm the selection of the antenna set.

3. The method of claim 2, further comprising:
in response to detecting high transmit packet error rates, reverting back to the another antenna set.

4. The method of claim 1, further comprising:
performing an antenna probe to a plurality of clients in round-robin fashion to minimize system performance degradation and maximize the antenna set adaptation capability for each client.

5. The method of claim 4, wherein the antenna probe is one of a partial antenna probe and a full antenna probe.

6. The method of claim 4, wherein performing the antenna probe further comprises:
scanning periodically for a better antenna set selection for each of the plurality of clients.

7. The method of claim 1, wherein both the first and the second channel packets include an antenna selection ID.

8. The method of claim 1, wherein the collected statistics includes information comprising at least one of the following:
first channel packet transmit success, first channel packet transmit fail, first channel packet transmit retry number, first channel packet initial and final modulation and coding scheme (MCS), first channel packet MCS at the receiver, first channel packet per-stream and per-receiver signal-to-noise ratio (SNR) at the receiver, first channel packet received signal strength indication (RSSI) at the receiver, second channel packet transmit success, second channel packet transmit fail, second channel packet transmit retry number, second channel packet initial and final MCS, second channel packet per-stream and per-receiver signal-to-noise ratio (SNR) at the transmitter, second channel packet MCS at the transmitter, and second channel packet received signal strength indication (RSSI) at the transmitter.

9. The method of claim 1, further comprising:
in response to the collected statistics and a distance between the transmitter and the receiver, adjusting transmission parameters on the transmitter and/or reception parameters on the receiver including any one of a transmission rate, a transmission stream mode, a transmission power, a transmission antenna set/ID, and a reception antenna set/ID.

10. The method of claim 1, wherein in response to failure of a transmission or a reception of the first channel packet or the second channel packet, a higher/upper network layer does not resend the first channel packet or the second channel packet.

11. A system comprising:
a processor; and
a memory device coupled to the processor, said memory device storing an application which, when executed by the processor, causes the processor to:
send a first channel packet from a transmitter to a receiver;
receive a second channel packet corresponding to the first channel packet;
collect statistics of an antenna set related to the first and the second channel packets; and
compare the collected statistics to previously collected statistics of another antenna set to select one of the antenna set and the another antenna set.

12. The system of claim 11, wherein the execution further causes the processor to:
in response to the selection of the antenna set, perform a network traffic check (NTC) after a predetermined time period to confirm the selection of the antenna set.

13. The system of claim 12, wherein the execution further causes the processor to:
in response to a detection of high transmit packet error rates, revert back to the another antenna set.

14. The system of claim 11, wherein the execution further causes the processor to:
perform an antenna probe to a plurality of clients in round-robin fashion to minimize system performance degradation and maximize the antenna set adaptation capability for each client.

15. The system of claim 14, wherein the antenna probe is one of a partial antenna probe and a full antenna probe.

16. The system of claim 14, wherein to perform the antenna probe further comprises:
to scan periodically for a better antenna set selection for each of the plurality of clients.

17. The system of claim 11, wherein both the first and the second channel packets include an antenna selection ID.

18. The system of claim 11, wherein the collected statistics includes information comprising at least one of the following:
first channel packet transmit success, first channel packet transmit fail, first channel packet transmit retry number, first channel packet initial and final modulation and coding scheme (MCS), first channel packet MCS at the receiver, first channel packet per-stream and per-receiver signal-to-noise ratio (SNR) at the receiver, first channel packet received signal strength indication (RSSI) at the receiver, second channel packet transmit success, second channel packet transmit fail, second channel packet transmit retry number, second channel packet initial and final MCS, second channel packet per-stream and per-receiver signal-to-noise ratio (SNR) at the transmitter, second channel packet MCS at the transmitter, and second channel packet received signal strength indication (RSSI) at the transmitter.

19. The system of claim 11, wherein the execution further causes the processor to:
in response to the collected statistics and a distance between the transmitter and the receiver, adjust transmission parameters on the transmitter and/or reception parameters on the receiver including any one of a transmission rate, a transmission stream mode, a transmission power, a transmission antenna set/ID, and a reception antenna set/ID.

20. The system of claim 11, wherein the first channel packet is any of a null data frame, a RTS frame, or a unicast management frame.
